(19) United States
(12) Patent Application Publication
(10) Pub. No.: US 2021/0256312 A1
(43) Pub. Date: Aug. 19, 2021

(54) ANOMALY DETECTION APPARATUS, METHOD, AND PROGRAM

(71) Applicants: NEC CORPORATION, Tokyo (JP); NATIONAL UNIVERSITY CORPORATION TOKAI NATIONAL HIGHER EDUCATION AND RESEARCH SYSTEM, Nagoya-shi, Aichi (JP)

(72) Inventors: Tatsuya KOMATSU, Tokyo (JP); Reishi KONDO, Tokyo (JP); Tomoki HAYASHI, Aichi (JP)

(73) Assignees: NEC CORPORATION, Tokyo (JP); NATIONAL UNIVERSITY CORPORATION TOKAI NATIONAL HIGHER EDUCATION AND RESEARCH SYSTEM, Nagoya-shi, Aichi (JP)

(21) Appl. No.: 17/056,070

(22) PCT Filed: May 18, 2018
(86) PCT No.: PCT/JP2018/019285

§ 371 Date: Nov. 17, 2020

(51) Int. Cl. G06K 9/62; G06N 3/08

(52) U.S. Cl. CPC G06K 9/6257; G06N 3/08; G06K 9/6232

(57) ABSTRACT

An anomaly detection apparatus comprises a pattern storage part, first long time-span feature extraction part, a pattern feature calculation part, and a score calculation part. The pattern storage part stores a signal pattern model trained based on an acoustic signal for training in a first time-span and a feature for training being calculated from signal for training in a second time-span that is longer than first time-span. The first long time-span feature extraction part extracts a long time-span feature for detection associated with the feature for training from a signal being a detection target. The pattern feature calculation part calculates a signal pattern feature related to a signal being a detection target based on the signal being a detection target, the feature for detection, and the signal pattern model. The score calculation part calculates score to detect anomaly in the signal being detection target.

### CROSS REFERENCE TO RELATED APPLICATIONS

This application is a National Stage of International Application No. PCT/JP2018/019285 filed May 18, 2018.

### TECHNICAL FIELD

The present invention relates to an anomaly detection apparatus, an anomaly detection method, and a program.

### BACKGROUND

Non Patent Literature 1 discloses a technology in which with respect to acoustic signals inputted sequentially, a detector trained with signal pattern included in an acoustic signal in a normal condition is used as a model of a generating mechanism that generates an acoustic signal in a normal condition. A technology disclosed in Non Patent Literature 1 detects a signal pattern, as anomaly, that is a statistical outlier from the generating mechanism under the normal condition by calculating outlier score based on the detector and a signal pattern in an input of the acoustic signal.
[Non Patent Literature (NPL) 1] Marchi, Erik, et al. “Deep Recurrent Neural Network-Based Autoencoders for Acoustic Novelty Detection.” Computational intelligence and neuroscience 2017 (2017)

### SUMMARY

Each of the disclosures in the above prior art references shall be carried forward to this document by reference. The following analysis is given by the present invention.

According to the technology disclosed in NPL 1, there is a problem that it cannot detect anomaly in case where the acoustic signal generating mechanism holds a plurality of states and the signal pattern generated in each state is different from one another. For example, consider that a generating mechanism holds two states such as a state A and a state B. Further consider that state A generates a signal pattern 1 and state B generates a signal pattern 2 in a normal condition, and state A generates a signal pattern 2 and state B generates a signal pattern 1 in anomaly condition. In this case, according to the technology disclosed in NPL 1, it will be modeled such that the generating mechanism generates a signal pattern 1 and a signal pattern 2, irrespective of the difference in states of the generating mechanism, and the detection of anomaly which is to be truly detected will fail.

It is a main object of the present invention to provide an anomaly detection apparatus, an anomaly detection method and a program that contribute to detecting anomaly from an acoustic signal generated by a generating mechanism providing (or subject to) a state change.

According to a first aspect of the present invention or disclosure, there is provided an anomaly detection apparatus, comprising: a pattern storage part that stores a signal pattern model trained based on an acoustic signal for training in a first time-span, and a long time feature for training calculated from an acoustic signal for training in a second time-span that is longer than the first time-span; a first long time-span feature extraction part that extracts a long time-span feature for anomaly detection associated with the long time feature for training from an acoustic signal being a target of anomaly detection; a pattern feature calculation part that calculates a signal pattern feature related to an acoustic signal being a target of anomaly detection based on the acoustic signal being a target of anomaly detection, the long time feature for anomaly detection and the signal pattern model; and a score calculation part that calculates an anomaly score to detect anomaly in the acoustic signal being a target of anomaly detection, based on the signal pattern model.

According to a second aspect of the present invention or disclosure, there is provided an anomaly detection method, in an anomaly detection apparatus that comprises a pattern storage part that stores a signal pattern model trained based on an acoustic signal for training in a first time-span, and a long time feature for training calculated from an acoustic signal for training in a second time-span that is longer than the first time-span, the method comprising: extracting a long time-span feature for anomaly detection associated with the long time feature for training from an acoustic signal being a target of anomaly detection; calculating a signal pattern feature related to an acoustic signal being a target of anomaly detection based on the acoustic signal being a target of anomaly detection, the long time feature for anomaly detection and the signal pattern model; and calculating an anomaly score to detect anomaly in the acoustic signal being a target of anomaly detection, based on the signal pattern model.

According to a third aspect of the present invention or disclosure, there is provided a program for causing a computer installed in an anomaly detection apparatus that comprises a pattern storage part that stores a signal pattern model trained based on an acoustic signal for training in first time-span, and a long time feature for training calculated from an acoustic signal for training in a second time-span that is longer than the first time-span, to execute: a process of extracting a long time-span feature for anomaly detection associated with the long time feature for training from an acoustic signal being a target of anomaly detection; a process of calculating a signal pattern feature related to an acoustic signal being a target of anomaly detection based on the acoustic signal being a target of anomaly detection, the long time feature for anomaly detection and the signal pattern model; and a process of calculating an anomaly score to detect anomaly in the acoustic signal being a target of anomaly detecting, based on the signal pattern model.

According to the present invention, it is possible to detect anomaly from an acoustic signal generated by a generating mechanism providing a state change.

### BRIEF DESCRIPTION OF THE DRAWINGS

FIG. 1 is a block diagram showing an outline of an exemplary embodiment of the present invention.

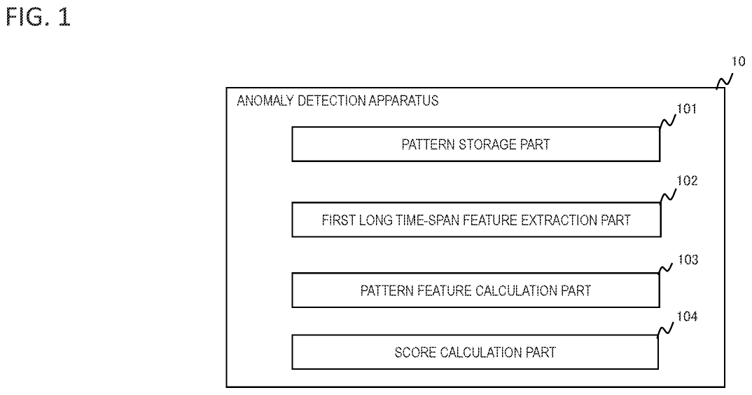

FIG. 2 is a diagram showing a processing configuration of an anomaly detection apparatus of a first exemplary embodiment.

FIG. 3 is a diagram showing a processing configuration of an anomaly detection apparatus of a second exemplary embodiment.

FIG. 4 is a flowchart showing an operation of an anomaly detection apparatus of the second exemplary embodiment.

FIG. 5 is a flowchart showing an operation of an anomaly detection apparatus of the second exemplary embodiment.

FIG. 6 is a diagram showing a processing configuration of an anomaly detection apparatus of a third exemplary embodiment.

FIG. 7 is a diagram showing a hardware configuration of the anomaly detection apparatuses according to the first to third exemplary embodiments.

### PREFERRED MODES

First, an outline of one mode of this invention will be described with reference to the drawings. Reference numbers attached to the drawings in this outline are provided for convenience as an example for facilitating understanding, and not intended to limit the present invention to the illustrated modes. And each connection line between blocks in the referenced drawings appearing in the following description includes both bi-directional and single-directional. A single-directional arrow describes main data flow schematically, which, however, does not exclude bi-directionality. There are input port and output port, respectively in each joint point of block diagram in the figures, while not illustrated in the figures. The same applies to input/output interfaces.

An anomaly detection apparatus 10 comprises pattern storage part 101, a first long time-span feature extraction part 102, a pattern feature calculation part 103, and a score calculation part 104. A pattern storage part 101 stores a signal pattern model trained based on an acoustic signal(s) for training in a first time-span, and a long time feature for training calculated from an acoustic signal(s) for training in a second time-span that is longer than the first time-span. A first long time-span feature extraction part 102 extracts a long time-span feature for anomaly detection associated with the long time feature for training from an acoustic signal being a target of anomaly detection. A pattern feature calculation part 103 calculates a signal pattern feature related to an acoustic signal being a target of anomaly detection based on the acoustic signal being a target of anomaly detection, the long time feature for anomaly detection and the signal pattern model. A score calculation part 104 calculates an anomaly score to detect anomaly in the acoustic signal being a target of anomaly detection, based on the signal pattern model(s).

The above-described anomaly detection apparatus 10 realizes an anomaly detection based on outlier detection with respect to an acoustic signal(s). In addition to the signal pattern obtained from the acoustic signal(s), the anomaly detection apparatus 10 performs the outlier detection using a long time feature, which is a feature corresponding to a state of the generator mechanism, in addition to the signal pattern(s) obtained from the acoustic signal(s). Therefore, the outlier pattern can be detected in accordance with the change of state in the generator mechanism. That is, the anomaly detection system 10 can detect anomalies from the acoustic signals generated by the generating mechanism subject to a state change.

A more detail of a specific exemplary embodiment will be described with the reference to the drawings below. In each exemplary embodiment, the same configurating elements are identified with the same sign and the description thereof is omitted.

### FIRST EXEMPLARY EMBODIMENT

A more detail of a first exemplary embodiment will be described with the reference to the drawings.

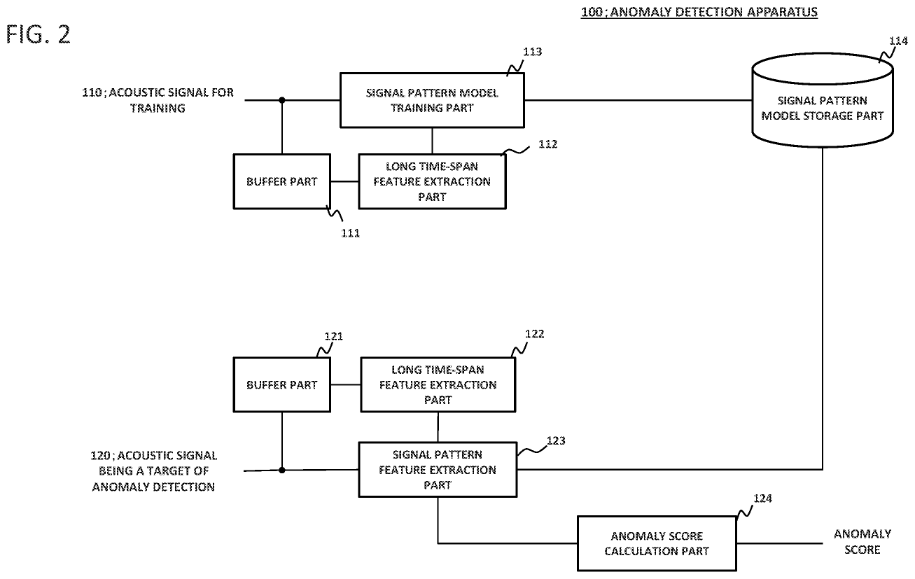

FIG. 2 is a diagram showing a processing configuration (a processing module) of an anomaly detection apparatus 100 of the first exemplary embodiment. Referring to FIG. 2, an anomaly detection apparatus 100 comprises a buffer part 111, a long time feature extraction part 112, a signal pattern model training part 113, and a signal pattern model storage part 114. The anomaly detection apparatus 100 further comprises a buffer part 121, a long time feature extraction part 122, a signal pattern feature extraction part 123, and an anomaly score calculation part 124.

A buffer part 111 receives an acoustic signal(s) for training 110 as input, buffers the acoustic signal(s) during a predetermined time-span, and outputs.

The long time feature extraction part 112 receives the acoustic signal(s) that the buffer part 111 outputs as input, calculates a long time-span feature (long time feature vector), and outputs. A detail of long time feature will be described later.

The signal pattern model training part 113 receives an acoustic signal(s) for training 110 and a long time feature outputted by a long time feature extraction part 112 as inputs, trains (or learns) signal pattern model, and outputs the resultant model.

The signal pattern model storage part 114 stores the signal pattern model outputted by the signal pattern model training part 113.

The buffer part 121 receives an acoustic signal being a target of anomaly detection 120 as an input, buffers the acoustic signal for a predetermined time-span, and outputs.

The long time feature extraction part 122 receives an acoustic signal outputted by the buffer part 121 as an input, calculates and outputs a long time feature.

The signal pattern feature extraction part 123 receives an acoustic signal being a target of anomaly detection 120 and a long time feature outputted by the long time feature extraction part 122 as inputs, calculates and outputs a signal pattern feature based on the signal pattern model stored in the signal pattern model storage part 114.

The anomaly score calculation part 124 calculates and outputs anomaly score for detecting anomaly related on the acoustic signal being a target of anomaly detection based on a signal pattern feature outputted by the signal pattern feature extraction part 123.

In the anomaly detection apparatus 100 according to the first exemplary embodiment, a signal pattern model training part 113 trains signal pattern whereupon training (learning) is performed by using additional to the acoustic signal for training 110 a long time feature outputted by a long time feature extraction part 112 as auxiliary feature.

The long time feature mentioned above is calculated from buffered acoustic signal for training 110 during a predetermined time-span buffered in the buffer part 111, and the feature that includes statistical information corresponds to a plurality of signal patterns. The long time feature represents a statistical feature of what signal pattern acoustic signals are generated by the generating mechanism related to the training acoustic signal 110. The long time feature can be said to be a feature that represents the state of the generating mechanism in which the acoustic signal for training 110 is (or was) generated, when it has a plurality of states and the statistical features of the signal patterns generated by the generating mechanism in respective states are different. In other words, the signal pattern model training part 113 trains, in addition to the signal pattern included in the acoustic signal for training 110, information about the state of the generating mechanism in which the signal pattern was generated as a feature.

A buffer part 121 and a long time feature extraction part 122 calculate a long time feature from an acoustic signal being a target of anomaly detection by the similar operation as the buffer part 111 and the long time feature extraction part 112, respectively.

The signal pattern feature extraction part 123 receives an acoustic signal being a target of anomaly detection 120 and a long time feature calculated from the long time feature 120 as inputs, and calculates a signal pattern feature based on the signal pattern model stored in the signal pattern model storage part 114. In the first exemplary, additional to the acoustic signal being a target of anomaly detection 120, the long time feature which is a feature corresponding to the state of generating mechanism, therefore detection can be made of as outlier pattern corresponding to change in the state of the generating mechanism.

The signal pattern features calculated in the signal pattern feature extraction part 123 are converted into anomaly score in the anomaly score calculation part 124, followed by outputting.

As described above, the anomaly detection technique of NPL 1 performs modeling of the generating mechanism irrespective of distinction of the state of the generating mechanism by using only the signal pattern in the input acoustic signal. As a result, the technique of the NPL 1 cannot detect a true anomaly to be detected in a case where the generating mechanism has a plurality of states and the statistical properties of the signal patterns generated in individual states are different.

In contrast, according to the first exemplary embodiment, since the outlier detection is performed using a long time feature, which is a feature corresponding to the state of the generating mechanism, in addition to the signal pattern, the outlier pattern can be detected according to the change in the state of the generating mechanism. In other words, according to the first exemplary embodiment, an anomaly can be detected from an acoustic signal generated by the generating mechanism subject to a state change.

### SECOND EXEMPLARY EMBODIMENT

The second exemplary embodiment will now be described in detail with reference to the drawings. In the second exemplary embodiment, the contents of the first exemplary embodiment above will be described in more detail.

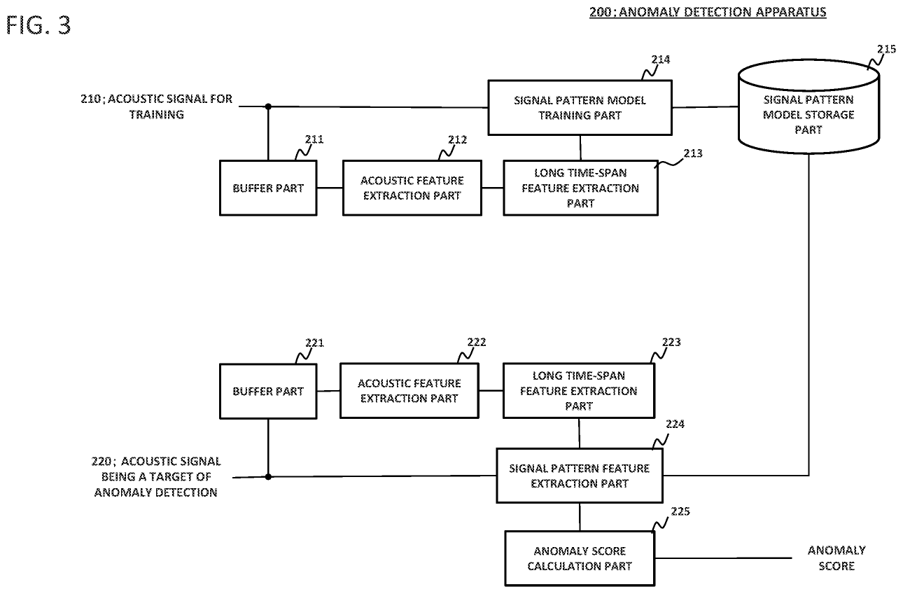

FIG. 3 illustrates an example of a processing configuration (processing module) of the anomaly detection apparatus 200 in the second exemplary embodiment. Referring to FIG. 3, the anomaly detection apparatus 200 includes a buffer part 211, an acoustic feature extraction part 212, a long time feature extraction part 213, a signal pattern model training part 214, and a signal pattern model storage part 215. Further, the anomaly detection apparatus 200 includes a buffer part 221, an acoustic feature extraction part 222, a long time feature extraction part 223, a signal pattern feature extraction part 224, and an anomaly score calculation part 225.

The buffer part 211 receives an acoustic signal for training 210 as an input, buffers the acoustic signal during a predetermined time-span, and outputs the acoustic signal.

The acoustic feature extraction part 212 receives the acoustic signal outputted from the buffer part 212 as an input and extracts acoustic feature that features the acoustic signal.

The long time feature extraction part 213 calculates and outputs a long time feature from the acoustic feature outputted by the acoustic feature extraction part 212.

The signal pattern model training part 214 receives the acoustic signal for training 210 and the long time feature outputted by the long time feature extraction part 213 as inputs, trains (learns) a signal pattern model, and outputs the resultant model.

The signal pattern model storage part 215 stores the signal pattern model outputted by the signal pattern model training part 214.

The buffer part 221 receives an acoustic signal being a target of anomaly detection 220 as an input, buffers the acoustic signal during a predetermined time-span, and outputs the resultant acoustic signal.

The acoustic feature extraction part 222 receives the acoustic signal outputted by the buffer part 221 as an input and extracts an acoustic feature that features the acoustic signal.

The long time feature extraction part 223 calculates and outputs a long time feature from the acoustic feature outputted by the acoustic feature extraction part 222.

The signal pattern feature extraction part 224 receives the acoustic signal being a target of anomaly detection 220 and the long time feature outputted by the long time feature extraction part 223 as inputs, calculates a signal pattern feature based on a signal pattern model stored in the signal pattern model storage part 215, and outputs the feature.

The anomaly score calculation part 225 calculates and outputs an anomaly score based on the signal pattern feature outputted by the signal pattern feature extraction part 224.

In the second exemplary embodiment, an anomaly detection will be described by way of an example in which x(t) as an acoustic signal for training 210 and y(t) as an acoustic signal being a target of an anomaly detection 220. Here, the acoustic signals x (t) and y (t) are digital signal series obtained by AD conversion (Analog to Digital Conversion) of an analog acoustic signal recorded by an acoustic sensor such as a microphone. t is an index representing time, which is the time index of the acoustic signals that are input sequentially for which a predetermined time is set as the origin t=0. Assume that a sampling frequency of each signal be Fs, a time difference between the adjacent time indices t and t+1, or the time resolution, is 1/Fs.

It is an object of the second exemplary embodiment to detect anomaly signal pattern in the acoustic signal generating mechanism in which the acoustic signals change from time to time. When considering an anomaly detection in public space as an example of application of the second exemplary embodiment, human activities or operations of instruments installed in the environment in which a microphone is installed, and surrounding environment etc. correspond to the generating mechanism of acoustic signals x(t), y(t).

The acoustic signal x(t) is a pre-recorded acoustic signal to train signal pattern model under a normal condition. The acoustic signal y(t) is an acoustic signal being a target of anomaly detection. Here, the acoustic signal x(t) needs to include only the signal pattern in anomaly condition (not in an anormal condition). However, if the time (length) of the signal pattern in the anomaly condition is smaller than the signal pattern in the normal condition, the acoustic signal x(t) can be statistically regarded as the acoustic signal in a normal condition.

The term “signal pattern” is a pattern of an acoustic signal series of a pattern length T set at a predetermined time width (e.g., 0.1 sec or 1 sec). The signal pattern vector X(t1) at time t1 of the acoustic signal x(t) can be written as X(t1)=[x(t1−T+1), . . . , x(t1)] using t1 and T. In the second exemplary embodiment, an anomaly signal pattern is detected based on the trained signal pattern model using the signal pattern vector X(t) in normal condition(s).

An operation of the second exemplary embodiment of anomaly detection apparatus 200 will be described below.

The acoustic signal x(t), which is the acoustic signal for training 210, is inputted to the buffer part 211 and the signal pattern model training part 214.

The buffer part 211 buffers a signal series with a time length R set in a predetermined time-span (e.g., 10 minutes, etc.) and outputs the same as a long time signal series [x(t−R+1), . . . , x(t)], where the time length R is set to a value greater than the signal pattern length T.

The acoustic feature extraction part 212 receives the long time signal series [x(t−R+1), . . . , x(t)] outputted by the buffer part 211 as an input, calculates the acoustic feature vector series G(t)=[g(1; t), . . . , g(N; t)], and outputs the resultant vector series.

The “N” in the acoustic feature vector series G(t) is the total number of time frames of the acoustic feature vector series G(t), corresponding to the time length R of the input long time signal series [x(t−R+1), . . . , x(t)].

G(n; t) is a longitudinal vector storing the K-dimensional acoustic features in the nth time frame among the acoustic feature vector series G(t) calculated from the long time signal series [x(t−R+1), x(t)]. The acoustic feature vector series G(t) is expressed as a value stored in a matrix of K rows and N columns storing the K-dimensional acoustic features in each of the N time frames.

Here, the time frame refers to the analysis window used to calculate g(n;t). The length of the analysis window (time frame length) is arbitrarily set by the user. For example, if the acoustic signal x(t) is an audio signal, g(n; t) is usually calculated from the signal in the analysis window of about 20 milliseconds (ms).

The time difference between adjacent time frames, n and n+1, or the time resolution, is arbitrarily set by the user. Usually, the time resolution is set to 50% or 25% of the time frame. In the case of an audio signal, it is usually set to about 10 ms, and if [g(1; t), g(N; t)] is extracted from [x(t−R+1), . . . , x(t)], which is set with a time length R=2 seconds, the total number of time frames N becomes 200.

The method of calculating the above K-dimensional acoustic feature vector g(1; t) will be explained in the second exemplary embodiment using the MFCC (Mel Frequency Cepstral Coefficient) feature as an example.

MFCC features are acoustic features that take into account human auditory characteristics and are used in many acoustic signal processing fields such as speech recognition. In case of using MFCC features, as the dimensional number K is the feature a number roughly of 10 to 20 is used usually. In addition, arbitrary acoustic features such as the amplitude spectrum calculated by applying short-time Fourier transform, the power spectrum, and the logarithmic frequency spectrum obtained by applying the wavelet transform, can be used depending on the type of the target acoustic signal.

That is, the above MFCC features are illustrative as an example, and various acoustic features suitable for the application of the system can be used. For example, if, contrary to human auditory characteristics, high frequencies are important, features can be used to emphasize the corresponding frequencies. Alternatively, if all frequencies need to be treated equally, the Fourier-transformed spectra of the time signal itself can be used as an acoustic feature. Moreover, for example, in the case of a sound source that is stationary within a long time range (e.g., in the case of a motor rotation sound), the time waveform itself can be used as an acoustic feature, and the statistics of the long time (e.g., mean and variance) can be used as a long time feature. Furthermore, the time waveform statistics (e.g., mean and variance) per short period of time (e.g., one minute) can be used as the acoustic features, and the statistics of the acoustic features over a long period of time can be used as the long time features. For example, the statistics obtained by expressing the acoustic features for each short time period by, for example, a mixed Gaussian distribution or by expressing the temporal variation by a hidden Markov model can be used as the long time features.

The long time feature extraction part 213 receives the acoustic feature vector series G(t)=[g(1; t), . . . , g(N; t)] outputted by the acoustic feature extraction part 212 as an input and outputs a long time feature vector h(t). The long time feature vector h(t) is calculated by applying statistical to the acoustic feature vector series G(t) and represents the statistical features of what signal patterns of the acoustic signal the generating mechanism generates at time t. In other words, the long time feature vector h(t) can be said as a feature that represents the state of the generating mechanism at time t at which the acoustic feature vector series G(t) and the long time signal series [x(t−R+1), . . . , x(t)], which was calculated from the acoustic feature vector series G(t), were generated.

With respect to the calculation method of the long time feature vector h(t), in the second exemplary embodiment explanation is given by using the Gaussian Super Vector (GSV) as an example. Each longitudinal vector g(n; t) of the acoustic feature vector series G(t) is regarded as a random variable, and the probability distribution p(g(n; t)) that g(n; t) follows is expressed by the Gaussian mixture model (Gaussian mixture model; GMM) as shown in the following Formula (1).

$$p ( g ( n ; t ) ) \text{∼} {\sum }_{i = 1}^{I} {ω}_{i} N ( {μ}_{i} , {\sum }_{i} ) \qquad [ Formula 1 ]$$

where i is the index of the Gaussian distribution, which is i is the index of each mixed element of the GMM and I is the number of mixtures; ωᵢ is the weight coefficient of the i-th Gaussian distribution; N(μᵢ, Σi) represents the Gaussian distribution for which the mean vector of the Gaussian distribution is pi and the covariance matrix is Σi; μi is a K-dimensional longitudinal vector of the same size as g(n; t), Σi is the square matrix of K rows and K columns. Here the subscript i is the mean vector and covariance matrix for the i-th Gaussian distribution.

As the estimation of the parameters ωᵢ, μᵢ, and Σᵢ of the GMM, the method of obtaining the most likely parameters about g(n; t) using the EM algorithm (Expectation-Maximization Algorithm) can be used. After the parameter estimation of the probability distribution p(g(n; t)), the GSV is a vector that combines the mean vector pi as a parameter characterizing p(g(n; t)) in the longitudinal direction for all i's in order, and in the second exemplary embodiment, said GSV is used for the long time feature vector h(t). In other words, the long time feature vector h(t) is as shown in the following Formula (2).

h(t)=[μ₁^{T}, . . . ,μ_{I}^{T}]^{T} [Formula 2]

Since the number of mixtures of GMMs is I and μ₁ is a K-dimensional longitudinal vector, the long time feature vector h(t) is a (K×I)-dimensional longitudinal vector. GSV, which is a feature that represents the shape of the distribution of GMM by a mean vector, corresponds to what probability distribution g(n; t) follows. Therefore, the long time feature vector h(t) is a feature that represents what kind of signal series [x(t−R+1), . . . , x(t)] is generated by the generating mechanism of the acoustic signal x(t) at time t, that is, a feature representing the state of the generating mechanism.

In the second exemplary embodiment, GSV was used to explain the method of calculating the long time feature vector h(t), but any other known probability distribution model or any feature that is calculated by applying statistical processing can be used. For example, a hidden Markov model for g(n; t) can be used, or a histogram for g(n; t) can be used as a feature as it is.

The signal pattern model training part 214 uses the acoustic signal x(t) and the long time feature vector h(t) outputted by the long time feature extraction part 213 to perform modeling a the signal pattern X(t).

The modeling method is described using “WaveNet” a type of neural network, in this present application disclosure. WaveNet is a prediction device that receives the signal pattern X(t)=[x(t−T+1), . . . , x(t)] at time t as input and estimates the probability distribution p(x(t+1)) that the acoustic signal x(t+1) follows.

In the second exemplary embodiment, the probability distribution p(x(t+1)) of x(t+1) is defined by using the input signal pattern X(t) plus a long time feature (long time feature vector) h(t) as an auxiliary feature. In other words, WaveNet is expressed as a probability distribution with the following Formula (3) conditioned by the signal pattern X(t) and the long time feature vector h(t).

p(x(t+1))˜p(x(t+1)|X(t),h(t),Θ) [Formula 3]

The Θ is a model parameter. In WaveNet, the acoustic signal x(t) is quantized to the C dimension by the μ-law algorithm and expressed as c(t), and p(x(t+1)) is expressed as a probability distribution p(c(t+1)) on a discrete set of C dimensions. Here, c(t) is the value of the acoustic signal x(t) quantized to the C dimension at time t, and is a random variable with a natural number from 1 to C as its value.

When inferring the model parameter Θ of p(c(t+1)|X(t), h(t)), processing is performed such that the cross entropy between p(c(t+1)|X(t), h(t)), calculated from X(t) and h(t), and the true value c(t+1) is minimized. The cross-entropy to be minimized can be expressed by the following Formula (4).

$$E = {\sum }_{t} {\sum }_{c} c ( t + 1 ) log p ( c ( t + 1 ) \vert X ( t ) , h ( t ) , Θ ) \qquad [ Formula 4 ]$$

In the second exemplary embodiment, in addition to the signal pattern X(t), a long time feature h(t) obtained from a long time signal is used as an auxiliary feature for the estimation of the probability distribution p(x(t+1)), which is a signal pattern model. In other words, not only the signal pattern contained in the acoustic signal for training, but also information about the state of the generating mechanism in which the signal pattern was generated is trained as a feature. Therefore, a signal pattern model can be trained according to the state of the generating mechanism. The trained model parameter(s) Θ is(are) outputted to the signal pattern model storage part 215.

In the second exemplary embodiment, a predictor of x(t+1) using the signal pattern X(t) based on WaveNet is described as an example of a signal pattern model, but modeling can also be performed using a predictor of the signal pattern model shown in Formula (5) below.

X(t+1)=f(X(t),h(t),Θ) [Formula 5]

The pattern model can also be estimated as a projection function from X(t) to X(t), as shown in Formula (6) and (7) below. In that case, the estimation of f(X(t), h(t)) can be modeled by a neural network model such as a self-coder or a factorization technique such as a non-negative matrix factorization or Principal Component Analysis (PCA).

X(t)=f(X(t),h(t),Θ) [Formula 6]

x(t)=f(X(t),h(t),Θ) [Formula 7]

The signal pattern model storage part 215 stores Θ for parameter of a signal pattern model outputted by the signal pattern model training part 214.

At the time of anomaly detection, the acoustic signal y(t), which is the acoustic signal 220 subject to anomaly detection, is input to the buffer part 221 and the signal pattern feature extraction part 224. The buffer part 221, the acoustic feature extraction part 222, and the long time feature extraction part 223 operate in the same manner as the buffer part 211, the acoustic feature extraction part 212, and the long time feature extraction part 213, respectively. The long time feature extraction part 223 outputs a long time feature (long time feature vector) h_y(t) of the acoustic signal y(t).

The signal pattern feature extraction part 224 receives as input the acoustic signal y(t), the long time feature h_y(t), and the parameter Θ of the signal pattern model stored in the signal pattern model storage part 215. The signal pattern feature extraction part 224 calculates a signal pattern feature about the signal pattern Y(t)=[y(t−T), . . . , y(t)] of the acoustic signal y(t).

In the second exemplary embodiment, with respect to the signal pattern model, it was represented as a predictor to estimate the probability distribution p(y(t+1)) that the acoustic signal y(t+1) follows at time t+1, using the signal pattern Y(t) at time t as input (Formula (8) below).

p(y(t+1))˜p(y(t+1)|Y(t),h_y(t),Θ) [Formula 8]

Here, assume that the acoustic signal y(t+1) is quantized to the C-dimension by the algorithm likewise the signal pattern model training part 214, the above Formula (8) can be expressed as equation (9) below, where c_y(t) is the value quantized to the C-dimension by the μ-law algorithm.

p(c_y(t+1))˜p(c_y(t+1)|Y(t),h_y(t),Θ) [Formula 9]

This is the predicted distribution of c_y(t+1) under the provision of signal pattern Y(t) and the long time feature h_y(t) at time t, based on the signal pattern model.

Here, at the time of training, the parameters Θ of the signal pattern model are trained from the signal pattern X(t) and the long time feature h(t) so that the accuracy of estimating c(t+1) is high. Therefore, the predictive distribution p(c(t+1)|X(t), h(t), and Θ) at the time the signal pattern X(t) and the long time feature h(t) be entered is such that the probability distribution has the highest probability at the true value c(t+1).

Now, consider the signal pattern Y(t) and the long time feature h_y(t) of the anomaly detection target signal. In this case, if there is a signal pattern X(t) conditioned to h(t) in the training signal that is similar to Y(t) conditioned to h_y(t), then p(c_y(t+1)|Y(t), h_y(t), and Θ) is considered to be a probability distribution such that it has a high probability at the true values c(t+1) corresponding to X(t) and h(t) used for training.

On the other hand, if a Y(t) conditioned to h_y(t), which is less similar to any of the X(t) conditioned to h(t) in the training signal is entered, that is, if Y(t) and h_y(t) are outliers compared to X(t) and h(t) at the time of training, prediction of p(c_y(t+1)|Y(t), h_y(t), Θ) will be uncertain. In other words, the distribution is expected to be flat. In other words, we can measure whether the signal pattern Y(t) is an outlier or not by checking the distribution of p(c_y(t+1)|Y(t), h_y(t), and Θ).

In the second exemplary embodiment, a signal pattern feature z(t) is used as a signal pattern feature z(t), which is expressed as a series of probability values in each case of a natural number from 1 to C, which is a possible value of c_y(t+1). In other words, the signal pattern feature z(t) is a vector of the C dimension represented by the following Formula (10).

z(t)=[p(1|Y(t),h_{y(t)},Θ), . . . ,p(C|Y(t),h_{y(t)},Θ)] [Formula 10]

The signal pattern feature z(t) calculated by the signal pattern feature extraction part 224 is converted into an anomaly score a(t) in the anomaly score calculation part 225 and is outputted. The signal pattern feature z(t) is a discrete distribution on a probability variable c taking values from 1 to C. If the probability distribution has a sharp peak, i.e., low entropy, then Y(t) is not an outlier. In contrast, if the probability distribution is close to a uniform distribution, i.e., high entropy, Y(t) is considered to be an outlier.

In the second exemplary embodiment, the entropy calculated from the signal pattern feature z(t) is used to calculate the anomaly score a(t) (see Formula (11) below).

$$a ( t ) = - {\sum }_{c} z ( t ) log z ( t ) = - {\sum }_{c} p ( c \vert Y ( t ) , {h}_{y ( t )} , Θ ) log p ( c \vert Y ( t ) , {h}_{y ( t )} , Θ ) \qquad [ Formula 11 ]$$

When the signal pattern Y(t) contains a signal pattern similar to the training signal, p(c|Y(t), h_y(t), Θ) has a sharp peak, that is, entropy a(t) is low. If the signal pattern Y(t) is an outlier that does not contain a signal pattern similar to the training signal, p(c|Y(t), h_y(t), Θ) becomes uncertain and close to a uniform distribution, i.e., the entropy a(t) is high.

Based on the obtained anomaly score a(t), an anomaly acoustic signal pattern is detected. For the detection, a threshold processing can be performed to determine the presence or absence of the anomaly, or further statistical or other processing can be added to the anomaly score a(t) as a time series signal.

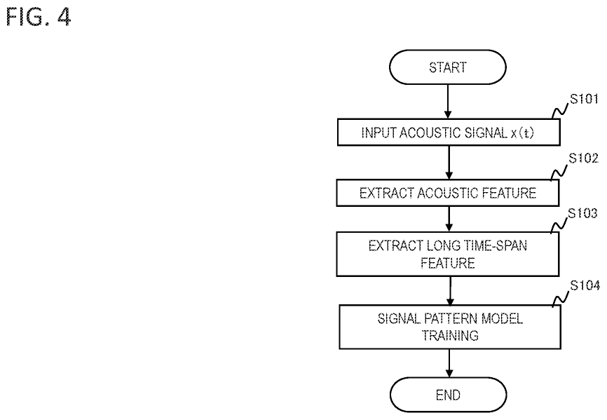

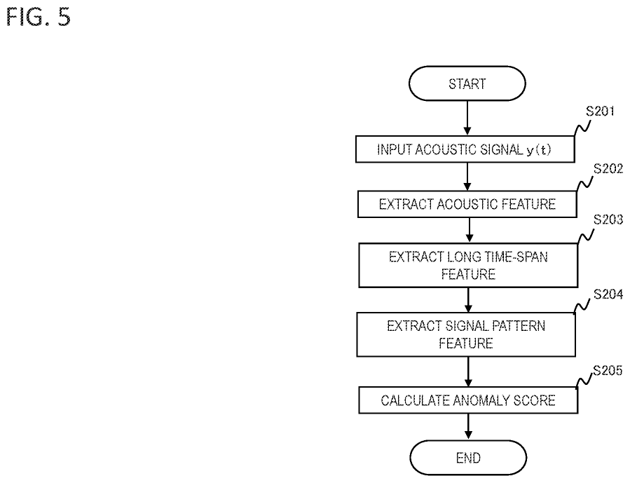

The operation of the anomaly detection apparatus 200 in the second exemplary embodiment above can be summarized as shown in the flowchart in FIGS. 4 and 5.

FIG. 4 shows an operation at the time of training model generation and FIG. 5 shows an operation at the time of anomaly detection processing.

Initially, in the training phase shown in FIG. 4, the anomaly detection apparatus 200 inputs an acoustic signal x(t) and buffers said acoustic signal (step S101). The anomaly detection apparatus 200 extracts (calculates) the acoustic features (step S102). The anomaly detection apparatus 200 extracts a long time feature for training based on the acoustic feature (step S103). The anomaly detection apparatus 200 trains the signal pattern based on the acoustic signal x(t) and the long time features for training (generating a signal pattern model; step S104). The generated signal pattern model is stored in the signal pattern model storage part 215.

Next, in the anomaly detection phase shown in FIG. 5, the anomaly detection apparatus 200 inputs the acoustic signal y(t) and buffers the acoustic signal (step S201). The anomaly detection apparatus 200 extracts (calculates) the acoustic features (step S202). The anomaly detection apparatus 200 extracts a long time feature for anomaly detection based on the acoustic feature (step S203). The anomaly detection apparatus 200 extracts (calculates) the signal pattern features based on the acoustic signal y(t) and the long time features for anomaly detection (step S204). The anomaly detection apparatus 200 calculates the anomaly score based on the signal pattern features (step S205).

The anomaly detection technique disclosed in the NPL 1 performs modeling of the generator mechanism using only the signal pattern in the input acoustic signal without distinguishing the states of the generator mechanism. Therefore, if the generating mechanism has multiple states and the statistical properties of the signal pattern generated in respective states are different, the anomaly to be truly detected cannot be detected.

On the other hand, according to the second exemplary embodiment, since the outlier detection is performed using a long time feature that is a feature corresponding to the state of the generating mechanism in addition to the signal pattern, the outlier pattern can be detected according to the change in the state of the generating mechanism. In other words, according to the second exemplary embodiment, the anomaly can be detected from an acoustic signal generated by the generating mechanism providing a state change.

### Third Exemplary Embodiment

A third exemplary embodiment will now be described in detail with reference to the drawings.

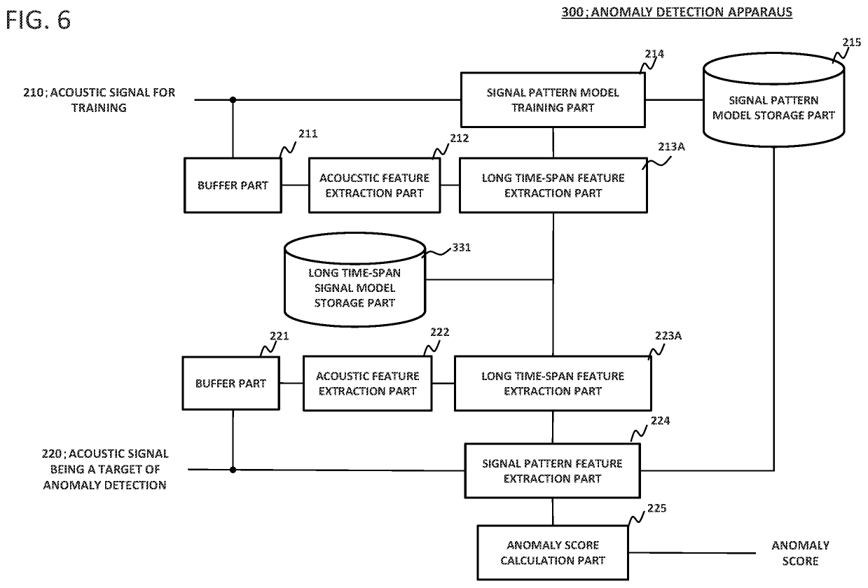

FIG. 6 illustrates an example of a processing configuration (processing module) of the anomaly detection apparatus 300 according to the third exemplary embodiment. Referring to FIG. 2 and FIG. 6, the anomaly detection apparatus 300 in the third exemplary embodiment is further provided with a long time signal model storage part 331.

In the second exemplary embodiment, modeling without the use of teacher data is explained with respect to long time feature extraction. In the third exemplary embodiment, the case of extracting long time features using a long time signal model is described. Concretely, the operation of the long time signal model storage part 331 and the changes in the long time feature extraction parts 213A and 223A are described. In the long time feature extraction part 213a, as in the second exemplary embodiment, the GSV is assumed to be calculated up to GSV h(t), using GSV as an example, and the following explanation is given.

A long time signal model H is stored in the long time signal model storage part 331 as a reference for extracting long time features in the long time feature extraction part 213A. Taking GSV as an example, one or more of GSV are stored therein, provided that the long time signal model H is a reference for the generating mechanism of the acoustic signal to be detected as an anomaly.

The long time feature extraction part 213A calculates the long time feature h_new(t) based on the signal pattern X(t) and the long time signal model H stored in the long time signal model storage part 331.

### [Case: Only Single GSV is Stored in H]

In the third exemplary embodiment, a new long time feature h_new(t) is obtained by taking the difference between the reference GSV h_ref stored in the long time signal model H and h(t) calculated from the signal pattern X(t) (see Formula (12) below).

h_{new}(t)=h(t)−h_{ref} [Formula 12]

For the calculation of h_ref, GSV calculated from the acoustic signal of the reference state, which is predetermined in the generating mechanism, is used. For example, if the target generating mechanism is divided into a main state and a sub state, h_ref is calculated from the acoustic signal of the main state and is stored in the long time signal model storage part 331.

h_new(t), defined as the difference between h(t) and h_ref, is obtained as a feature such that when the operating state of the generating mechanism with respect to the signal pattern x(t) is the main state, the element is almost zero, and in the case of the sub-state, the element representing the change from the main state has a large value. In other words, h_new(t) is obtained as a feature such that only elements that are more important to the change of the state, so that the subsequent training of the signal pattern model and the detection of anomaly patterns can be achieved with greater accuracy.

Here, as for the calculation method of h_ref, h_ref can be calculated not as a GSV calculated from a particular state, but as a GSV obtained by treating the acoustic signal without distinguishing all the states. In that case, it can be said that h_ref represents the global features of the generating mechanism of the acoustic signal, and h_new(t), which is represented by the difference therefrom, is a long time feature that emphasizes only the locally important element(s) that characterize respective state.

Alternatively, for h_new(t), we can use a factor analysis method like the i_vector feature used in speaker recognition to reduce the dimensionality of the final long time feature.

### [Case: A Plurality of GSVs are Stored in H]

In case of multiple GSVs are stored in a long time signal model H, each GSV is required to represent the state of the generating mechanism. Let the number of GSVs stored in the long time signal model H be M, and let the m-th GSV be h_m, then h_m is the GSV that represents the m-th state of the generating mechanism. In the third exemplary embodiment, based on each h_m, the identification of h(t) calculated from the signal pattern X(t) is performed, and the result is termed as a new long time feature h_new(t).

First, search is performed for h(t) and the closest h_m (see Formula (13) below).

$$*= {arg min}_{m} d ( h ( t ) m , {h}_{m} ) \qquad [ Formula 13 ]$$

In Formula (13), the d(h(t), h_m) denotes the distance between h(t) and h_m, using an arbitrary distance function such as cosine distance or Euclidean distance, and the smaller the value, the greater the similarity between h(t) and h_m. * gives the smallest d(h(t), h_*), i.e., the value of the index m of h_m that has the highest similarity to h(t). In other words, h(t) is closest to the state represented by h_*.

After finding *, a one-hot representation of *, etc. is used as h_new (t). Each h_m is extracted from the acoustic signal x_m(t) obtained from the m-th state beforehand. The method of calculating GSV is the same as the method described in the second exemplary embodiment as the operation of the long time feature extraction part 213, and the time width for calculating GSV is arbitrary and all x_m(t) can be used.

Compared with the second exemplary embodiment, which uses the long time feature itself, the third exemplary embodiment uses a new long time feature obtained by categorizing classifying the states in advance, and thus the third exemplary embodiment can perform modeling of the state with higher accuracy, and as a result, can detect anomalies with higher accuracy.

### [Hardware Configuration]

The hardware configuration of anomaly detection apparatus in the above-mentioned exemplary embodiments are described.

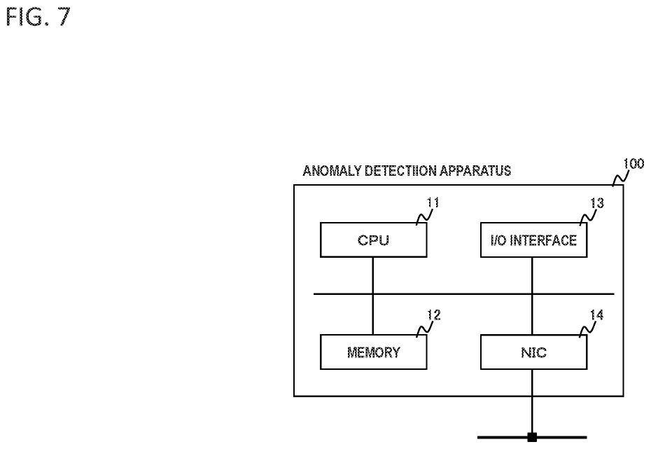

FIG. 7 shows an example of a hardware configuration of the anomaly detection apparatus 100. The anomaly detection apparatus 100 is implemented by an information processing device (computer) and has the configuration shown in FIG. 7. For example, the anomaly detection apparatus 100 has a Central Processing Unit (CPU) 11, a memory 12, an I/O Interface 13, a Network Interface Card (NIC) 14, etc., which are interconnected by an internal bus, and the like. The configuration shown in FIG. 7 is not intended to limit the hardware configuration of the anomaly detection apparatus 100. The anomaly detection apparatus 100 can also include hardware not shown in the figure, and can be without NIC 14 and the like as required.

The memory 12 is Random Access Memory (RAM), Read Only Memory (ROM), Hard Disk Drive (HDD), etc.

The I/O Interface 13 is a means to be an interface for an I/O device not shown in the figure. The I/O device includes, for example, a display device, an operation device, and the like. The display device is, for example, a liquid crystal display or the like. The operation device is, for example, a keyboard, a mouse, and the like. An interface connected to an acoustic sensor or the like is also included in the input/output interface 13.

Each processing module of the above-described anomaly detection apparatus 100 is implemented, for example, by the CPU 11 executing a program stored in the memory 12. The program can be downloaded over a network or updated by using a storage medium storing the program. Further, the above processing module can be realized by a semiconductor chip. That is, there may be means of executing the functions performed by the above processing modules in any hardware and/or software.

### Other Exemplary Embodiments (Variations)

Although the application disclosure has been described herein with reference to exemplary embodiments, the application disclosure is not limited to the above exemplary embodiments. The configuration and details of the application can be modified in various ways that are within the scope of the application disclosure and are understandable to those skilled in the art. In addition, any system or device that combines the separate features included in the respective exemplary embodiments in any way is also included within the scope of this application disclosure.

In particular, an example of configuration including a training module inside of an anomaly detection apparatus 100 and the like being described, but the signal pattern model training can be performed by another device and the trained model can be inputted to anomaly detection apparatus 100 and the like.

By installing the anomaly detection program in the memory part of the computer, the computer can function as an anomaly detection apparatus. And by executing the anomaly detection program in the computer, the anomaly detection method can be executed by the computer.

Although the plurality of processes (processes) are described in the plurality of flowcharts used in the above-described description, the order of execution of the processes executed in each exemplary embodiment is not limited to the described order. In each exemplary embodiment, the order of the illustrated processes can be changed to the extent that it does not interfere with the content, for example, each of processes is executed in parallel. Also, each of the above-described exemplary embodiments can be combined to the extent that the contents do not conflict with each other.

The present application disclosure can be applied to a system comprising a plurality of devices and can be applied to a system comprising a single device. Furthermore, the present application disclosure can be applied to an information processing program that implements the functions of above-described exemplary embodiments is supplied directly or remotely to a system or a device. Thus, a program installed on a computer, or a medium storing the program, or a World Wide Web (WWW) server that causes the program to be downloaded in order to implement the functions of the present application disclosure on a computer is also included in the scope of the present application disclosure. In particular, at least a non-transitory computer readable medium storing a program that causes a computer to perform the processing steps included in the above-described exemplary embodiments are included in the scope of the disclosure of this application.

Some or all of the above exemplary embodiments can be described as in the following Modes, but not limited to the following.

### [Mode 1]

(Refer to above anomaly detection apparatus of the first aspect of the present invention.)

### [Mode 2]

The anomaly detection apparatus as described in Mode 1, further comprising: a buffer part that buffers the acoustic signal for anomaly detection during at least the second time-span.

### [Mode 3]

The anomaly detection apparatus as described in Mode 2, further comprising: an acoustic feature extraction part that extracts an acoustic feature based on the acoustic signal for anomaly detection that is outputted from the buffer part, wherein the first long time-span feature extracting part extracts the long time-span feature for anomaly detection based on the acoustic feature.

### [Mode 4]

The anomaly detection apparatus as described in any one of the Modes 1 to 3, wherein the signal pattern model is a prediction device that estimates a probability distribution to be followed by the acoustic signal being a target of the anomaly detection at time t+1 by receiving an input of the acoustic signal being a target of the anomaly detection at time t.

### [Mode 5]

The anomaly detection apparatus as described in Mode 4, wherein the signal pattern feature is expressed as a series of probability values for each possible value taken by the acoustic signal being a target of anomaly detection at time t+1, and the score calculation part calculates an entropy of the signal pattern feature, and calculates the anomaly score using the calculated entropy.

### [Mode 6]

The anomaly detection apparatus as described in any one of Modes 1-5, further comprising: a model storage part that stores a long time-span signal model at least as a reference to extract the long time-span feature for anomaly detection, wherein the first long time-span feature extraction part extracts the long time-span feature with further reference to the long time-span signal model for anomaly detection.

### [Mode 7]

The anomaly detection apparatus as described in any one of Modes 1-6, wherein the acoustic signal for training and the acoustic signal for anomaly detection are acoustic signals generated by a generating mechanism providing a change of state.

### [Mode 8]

The anomaly detection apparatus as described in any one of Modes 1-7, further comprising: a second long time-span feature extraction part that extracts the long-time span feature for training, and a training part that performs training of the signal pattern model based on the acoustic signal for training and the long time-span feature for training.

### [Mode 9]

The anomaly detection apparatus as described in Mode 3, wherein the acoustic feature is a Mel Frequency Cepstral Coefficient (MFCC) feature.

### [Mode 10]

The anomaly detection apparatus as described in Mode 8, wherein the training part performs modeling of the signal pattern of the acoustic signal for training by utilizing neural network.

### [Mode 11]

(Refer to the above anomaly detection method according to the second aspect of the present invention)

### [Mode 12]

(Refer to the above anomaly detection program according to the third aspect of the present invention)

Mode 11 and Mode 12 can be expanded to Modes 2 to 10 likewise as Mode 1.

It is to be noted that each of the disclosures in the abovementioned Patent Literatures etc. is incorporated herein by reference. Modifications and adjustments of exemplary embodiments and examples are possible within the bounds of the entire disclosure (including the claims) of the present invention, and also based on fundamental technological concepts thereof. Furthermore, a wide variety of combinations and selections of various disclosed elements is possible within the scope of the claims of the present invention. That is, the present invention clearly includes every type of transformation and modification that a person skilled in the art can realize according to the entire disclosure including the claims and technological concepts thereof. In particular, with respect to the numerical ranges described in the present application, any numerical values or small ranges included in the ranges should be interpreted as being specifically described even if not otherwise explicitly recited.

### SIGNS LIST

10, 100, 200, 300 Anomaly detection apparatus
11 CPU
12 Memory
13 I/O Interface
14 NIC
101 Pattern storage part
102 First long time-span feature extraction part
103 Pattern feature calculation part
104 Score calculation part
111, 121, 211, 221 Buffer part
112, 122, 213, 223, 213a, 223a Long time-span feature extraction part
113, 214 Signal pattern model training part
114, 215 Signal pattern model storage part
123, 224 Signal pattern feature extraction part
212, 222 Acoustic feature extraction part
331 Long time-span signal model storage part

1. An anomaly detection apparatus, comprising:
a memory configured to store instructions, and
a processor configured to execute the instructions,
the instructions comprising:
storing a signal pattern model trained based on an acoustic signal for training in a first time-span, and a long time feature for training calculated from an acoustic signal for training in a second time-span that is longer than the first time-span;
extracting a long time-span feature for anomaly detection associated with the long time feature for training from an acoustic signal being a target of anomaly detection;
calculating a signal pattern feature related to an acoustic signal being a target of anomaly detection based on the acoustic signal being a target of anomaly detection, the long time feature for anomaly detection and the signal pattern model; and
a score calculating an anomaly score to detect anomaly in the acoustic signal being a target of anomaly detection, based on the signal pattern model.

2. The anomaly detection apparatus according to claim 1, wherein the instructions further comprise:
buffering the acoustic signal for anomaly detection during at least the second time-span.

3. The anomaly detection apparatus according to claim 2, wherein the instructions further comprise:
extracting an acoustic feature based on the acoustic signal for anomaly detection that is outputted from the buffer part, and
extracting the long time-span feature for anomaly detection based on the acoustic feature.

4. The anomaly detection apparatus according to claim 1, wherein the signal pattern model is a prediction device that estimates a probability distribution to be followed by the acoustic signal being a target of the anomaly detection at time t+1 by receiving an input of the acoustic signal being a target of the anomaly detection at time t.

5. The anomaly detection apparatus according to claim 4, wherein the signal pattern feature is expressed as a series of probability values for each possible value taken by the acoustic signal being a target of anomaly detection at time t+1, and
the score calculating an entropy of the signal pattern feature, to calculate the anomaly score using the calculated entropy.

6. The anomaly detection apparatus according to claim 1, wherein the instructions further comprise:
storing a long time-span signal model at least as a reference to extract the long time-span feature for anomaly detection,
wherein the extracting extracts the long time-span feature with further reference to the long time-span signal model for anomaly detection.

7. The anomaly detection apparatus according to claim 1, wherein the acoustic signal for training and the acoustic signal for anomaly detection are acoustic signals generated by a generating mechanism providing a change of state.

8. The anomaly detection apparatus according to claim 1, wherein the instructions further comprise:
extracting the long-time span feature for training, and
performing training of the signal pattern model based on the acoustic signal for training and the long time-span feature for training.

9. An anomaly detection method, in an anomaly detection apparatus that comprises a pattern storage part that stores a signal pattern model trained based on an acoustic signal for training in a first time-span, and a long time feature for training calculated from an acoustic signal for training in a second time-span that is longer than the first time-span,
the method comprising:
extracting a long time-span feature for anomaly detection associated with the long time feature for training from an acoustic signal being a target of anomaly detection;
calculating a signal pattern feature related to an acoustic signal being a target of anomaly detection based on the acoustic signal being a target of anomaly detection, the long time feature for anomaly detection and the signal pattern model; and
calculating an anomaly score to detect anomaly in the acoustic signal being a target of anomaly detection, based on the signal pattern model.

10. A computer-readable recording medium storing a program for causing a computer installed in an anomaly detection apparatus that comprises a pattern storage part that stores a signal pattern model trained based on an acoustic signal for training in first time-span, and a long time feature for training calculated from an acoustic signal for training in a second time-span that is longer than the first time-span, to execute:
a process of extracting a long time-span feature for anomaly detection associated with the long time feature for training from an acoustic signal being a target of anomaly detection;
a process of calculating a signal pattern feature related to an acoustic signal being a target of anomaly detection based on the acoustic signal being a target of anomaly detection, the long time feature for anomaly detection and the signal pattern model; and
a process of calculating an anomaly score to detect anomaly in the acoustic signal being a target of anomaly detecting, based on the signal pattern model.

11. The anomaly detection method according to claim 9, further comprising:
buffering the acoustic signal for anomaly detection during at least the second time-span.

12. The anomaly detection method according to claim 11, further comprising:
extracting an acoustic feature based on the acoustic signal for anomaly detection that is outputted from the buffer part,
extracting the long time-span feature for anomaly detection based on the acoustic feature.

13. The anomaly detection method according to claim 9, wherein the signal pattern model is a prediction device that estimates a probability distribution to be followed by the acoustic signal being a target of the anomaly detection at time t+1 by receiving an input of the acoustic signal being a target of the anomaly detection at time t.

14. The anomaly detection method according to claim 13, wherein the signal pattern feature is expressed as a series of probability values for each possible value taken by the acoustic signal being a target of anomaly detection at time t+1, and
the score calculating an entropy of the signal pattern feature, to calculate the anomaly score using the calculated entropy.

15. The anomaly detection method according to claim 9, further comprising:
storing a long time-span signal model at least as a reference to extract the long time-span feature for anomaly detection,
wherein the extracting extracts the long time-span feature with further reference to the long time-span signal model for anomaly detection.

16. The anomaly detection method according to claim 9, wherein the acoustic signal for training and the acoustic signal for anomaly detection are acoustic signals generated by a generating mechanism providing a change of state.

17. The anomaly detection method according to claim 9, further comprising:
extracting the long-time span feature for training, and
performing training of the signal pattern model based on the acoustic signal for training and the long time-span feature for training.

18. The medium according to claim 10, the program further comprising:
buffering the acoustic signal for anomaly detection during at least the second time-span.

19. The medium according to claim 18, the program further comprising:
extracting an acoustic feature based on the acoustic signal for anomaly detection that is outputted from the buffer part, and
extracting the long time-span feature for anomaly detection based on the acoustic feature.

20. The medium according to claim 10, wherein the signal pattern model is a prediction device that estimates a probability distribution to be followed by the acoustic signal being a target of the anomaly detection at time t+1 by receiving an input of the acoustic signal being a target of the anomaly detection at time t.
